(19) United States
(12) Patent Application Publication
(10) Pub. No.: US 2013/0048689 A1
(43) Pub. Date: Feb. 28, 2013

(54) Container for Shopping Utensils

(71) Applicant: Jeremy J. Ling, St. Paul, MN (US)

(72) Inventor: Jeremy J. Ling, St. Paul, MN (US)

(21) Appl. No.: 13/557,985

(22) Filed: Jul. 25, 2012

Related U.S. Application Data
(60) Provisional application No. 61/574,051, filed on Jul. 27, 2011.

(51) Int. Cl. B62B 5/00

(52) U.S. Cl. 224/411

(57) ABSTRACT

A container for shopping utensils includes a storage cavity for receiving shopping bags, the cavity defined by rigid front and back panels, the panels opposingly positioned and operably movable towards and away from each other, a bottom panel connecting said front and back panels, the bottom panel defining a bottom end of the cavity, and a cavity opening for receiving the shopping bags, the cavity opening changeable in size as the front and back panels move away from each other and also as the panels move toward each other. A tensioning band is cooperatively engaged with the panels to limit the operable movement of the panels in the opposing direction away from each other. A cart attachment enables the container to be rapidly detachably engaged with a shopping cart.

### CROSS REFERENCE TO RELATED APPLICATIONS

The present application is related to U.S. Provisional Application Ser. No. 61/574,051, filed on Jul. 27, 2011, which application is incorporated by reference in its entirety.

### BACKGROUND

Many consumers bring their own re-useable shopping bags with them to the store. The re-useable shopping bags are commonly made from fabric, canvas, mesh, and/or plastics for example. These re-useable bags can reduce or eliminate the need to use disposable plastic or paper bags at the checkout. While re-useable shopping bags are environmentally advantageous, they are not without their shortcomings. For example, storing, carrying, and transporting multiple loose bags can be cumbersome and inconvenient. These bags can be rather bulky and may not be configured in a manner that makes their storage, transport, and carrying efficient and convenient. For example, they can create clutter during storage and transportation, such as in the car. Furthermore, carrying several loose bags from the car to the store can be cumbersome and inconvenient to manage. Furthermore, it's common to place the re-useable bags in the cart while shopping. However, the bags then occupy space where the shopping items are intended to be placed. Often, therefore, the bags end up getting buried under shopping items, which is problematic once the shopper arrives at the checkout counter as they must first unbury their bags before they can start packing items into the bags. Because of these types of inconvenience in storing, transporting, carrying, and managing re-useable shopping bags, many shoppers have not adopted the use of these bags.

Many consumers also carry a list/coupons/recipe cards/etc. and writing utensil with them to the store. A shopping list, for example, is intended to provide a list of items to be purchased, and therefore may be frequently interacted with during the course of shopping, for example, looking at the list, writing additional items on the list, or crossing off items that have already been selected etc. For efficiency and ease of use, the shopping list and writing utensil should ideally be located in a readily accessible location. Shopping lists are often constructed from a single or multiple pieces of paper, which by themselves do not provide adequate support for writing. Therefore, in addition to being readily accessible, it would also be beneficial to provide a writing surface that the list could be used in conjunction with. Shopping carts typically do not offer any sort of list holder or writing surface. As such, shopping lists tend to be stored in pockets or purses. Neither of these locations facilitates a convenient view of the list. Alternatively, many consumers will carry a list in their hand so that it is more accessible. However, carrying the list can be an inconvenience, especially when trying to push a cart, and/or pick up products off the shelf. Additionally, it is very difficult to write on the list when it is being hand carried and there is no adequate writing surface available. Because of these types of inconveniences, many consumers would consider alternatives that better facilitate carrying a shopping list and the surrounding activities that occur while interacting with the shopping list. Many consumers also carry various other items such as coupons, recipes, etc. It would also be desirable to position and organize these types of items such that the shopper can easily interact with them during the course of shopping.

### SUMMARY

Generally, the inventive aspects are directed to containers for shopping utensils, including re-useable shopping bags, shopping lists, writing utensils, coupons, recipes, and the like. Furthermore, the different embodiments of the container apparatus may provide user-friendly means for storing, compacting, transporting, carrying, and interacting with these shopping utensils. Furthermore, the apparatus can be attached to a cart such that the shopping utensils are readily accessible during the course of shopping.

According to one example aspect, the container apparatus of the present disclosure defines a cavity that can receive and hold re-useable shopping bags. The cavity includes rigid front and back opposing panels, joined by a bottom panel. The cavity can additionally include side panels. A tensioning band interacts with the front and back panels to define the cavity spacing between said front and back panels. In this manner, the tensioning band, in cooperation with the rigid front and back panels, can help compact shopping bags for more efficient storage. The container also includes a list holder that can be used to retain shopping lists, coupons, recipes, and the like. The list holder may allow these types of paper items to be easily attached and detached to the container in a clip like fashion. The list holder is attached to a rigid portion of the container that can act as a writing surface. The writing surface therefore allows users to easily write on the various paper items while they are attached to the container via the list holder. The apparatus may also provide structure for holding a writing device, such as a pen or pencil, to be used in conjunction with the list holder. The apparatus may also incorporate features that allow it to attach to a cart, for example hooks that allow it to hang from the handle of the cart. While hanging from the cart handle, the lists, writing utensil, and re-useable bags are all readily accessible to the shopper. Furthermore, when hanging by said hooks from the cart handle, the container is able to be pivoted about the cart handle axis into various positions. For example, the writing surface of the container may be oriented in a substantially vertical plane when freely hanging from the cart handle, but can be pivoted by the user such that the writing surface is oriented in a substantially horizontal plane. Pivoting the container such that the writing surface is in a substantially horizontal plane can make writing on the surface more convenient.

### BRIEF DESCRIPTION OF THE DRAWINGS

Drawings of some embodiments of the apparatus are included to assist in explaining the basic inventive ideas. These drawings are intended as illustrations and are not meant to limit the invention described herein.

FIG. 1: A side view of an apparatus/container for organizing shopping utensils. FIG. 1 illustrates a panel arrangement for containing shopping bags as well as an elastic cord to further help contain and collapse the shopping bags.

FIG. 2: A perspective view of the apparatus/container for organizing shopping utensils. FIG. 2 illustrates attachment hooks for interfacing with a shopping cart as well as a closure strap across the top opening.

FIG. 3: Another perspective view of the apparatus/container for organizing shopping utensils. FIG. 3 illustrates the container attached to a shopping cart.

FIG. 4: Another perspective view of the apparatus/container for organizing shopping utensils. FIG. 4 illustrates a list holder and a pen holder of the container.

FIG. 5: A front view of the apparatus/container for organizing shopping utensils. FIG. 5 illustrates a carrying handle attached to the container.

FIG. 6A: A perspective view of another embodiment of a container attached to a cart. FIG. 6A illustrates the container hanging from a cart handle.

FIG. 6B: A perspective view of the container attached to the cart. FIG. 6B illustrates the container hanging from the top frame of the cart.

FIG. 7: Another perspective view of the container. FIG. 7 illustrates a panel arrangement defining a cavity configured for re-useable shopping bags.

FIG. 8: Another perspective view of the container. FIG. 8 illustrates various features of the container.

FIG. 9: Another perspective view of the container. FIG. 9 illustrates the container attached to a cart handle, and pivoted into a preferred writing/viewing position.

FIG. 10: Another perspective view of the container. FIG. 10 illustrates a pocket attached to an outer surface of the container.

### DETAILED DESCRIPTION

The subject matter described herein may take form in a variety of embodiments, including but not limited to, the embodiments, components, arrangements of components, assembly methods and arrangements of methods, and apparatus usage procedures and arrangements of procedures as described below. The embodiments described, while possibly being preferred embodiments, are illustrative examples and are not meant to limit the inventive aspects described herein.

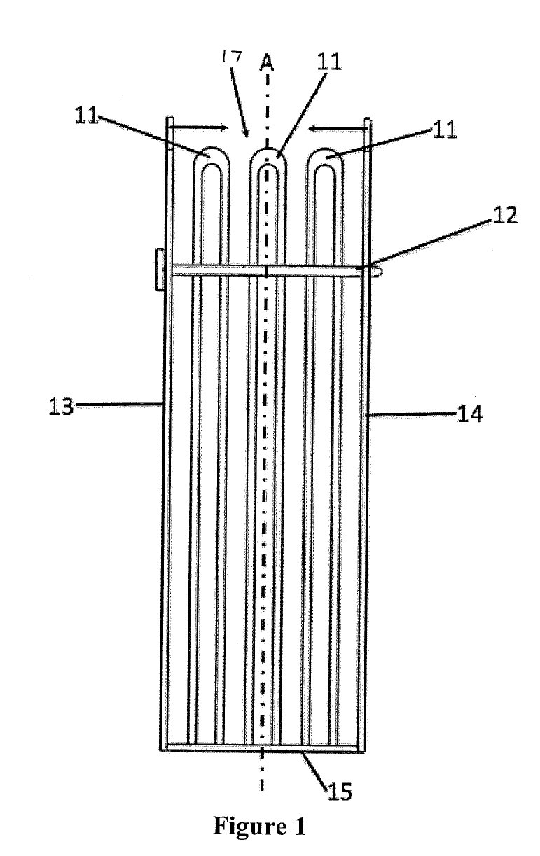

Various embodiments of a container 10 for shopping utensils are illustrated in FIGS. 1-5. In this context, shopping utensils may for example include re-useable shopping bags, lists/coupons/recipes/etc. and a writing utensil.

FIG. 1 illustrates a container 10 constructed with a front panel 13, back panel 14, and bottom panel 15. The panel arrangement serves as a container for holding items such as re-useable shopping bags 11. In FIG. 1, three re-useable shopping bags are illustrated as being contained within the panels; the bags are illustrated folded approximately in half. In a preferred embodiment the panels 13 and 14 could be made from a rigid or semi-rigid material, such that the rigid walls help collapse the bags 11. The front panel 13, back panel 14, and bottom panel 15 may be separate panels joined together, or alternatively could be efficiently fabricated from a single sheet cut and then formed into the front, back, and bottom panel configuration.

As illustrated, this embodiment may eliminate the use of side panels, which allows front panel 13 and back panel 14 to fold inwardly towards axis A as indicted by the arrows in FIG. 1. As the panels 13, 14 fold inward, the re-useable bags 11 can be collapsed and retained. Collapsible side panels could alternatively be incorporated to further conceal and retain the bags without disrupting the ability of the rigid panels to collapse inward on the bags. A collapsible side panel could, for example, be constructed of any number of pliable materials, such as fabric, mesh, folded sheeting etc. Such thin, pliable materials could act as end caps that occupy some portion of the side wall space between the front panel 13 and back panel 14.

In the illustrated example, the embodiment of the container 10 does not include a top panel. Lack of a top panel may facilitate quick, easy loading and unloading of the bags 11 through the top opening 17. An elastic cord 12 can serve to tension front panel 13 and back panel 14 toward axis A as indicated by the arrows in FIG. 1. As a result, the elastic cord can help further promote collapsing and retainment of the re-useable bags 11 for efficient storage. The elastic cord 12 for example, could be a single cord spanning across the open side wall area between front panel 13 and back panel 14 as illustrated in FIG. 1. Alternatively, many other elastic cord configurations could be accomplished such as multiples elastic cords, elastic cord(s) wrapped fully around the perimeter of the container, elastic cord(s) woven in various patterns back and forth between panels, etc. In addition to assisting with collapse and containment of the bags 11, elastic cord 12 may also serve as an easy open/close mechanism. For example, to load or remove a bag 11 from the container 10, the user simply has to separate front panel 13 from back panel 14. While separating the front panel 13 and back panel 14, the elastic cord(s) will easily stretch allowing the top opening 17 to enlarge for quick and easy loading/unloading of re-useable bags 11. In this manner, no user interactions are required with the elastic cord(s), the user can simply open the panels 13, 14 to gain access to the bags 11, and then subsequently release the panels 13, 14 to allow them to collapse back down. Other features for tensioning panels 13 and 14 could be accomplished via tie strings, latches, buckles, tensioning straps, etc.

In addition to the easy open/close mechanism accomplished with the elastic cords 12 and top opening 17, the elastic cord 12 can also provide a limit on how far the top opening 17 can open. In this manner, the top opening 17 can be enlarged far enough to facilitate easy loading/unloading of the bags 11, but not so far that bags 11 could unintentionally fall out of the container 10. In contrast, an alternative embodiment previously described could use tie strings to tension the panels 13 and 14.

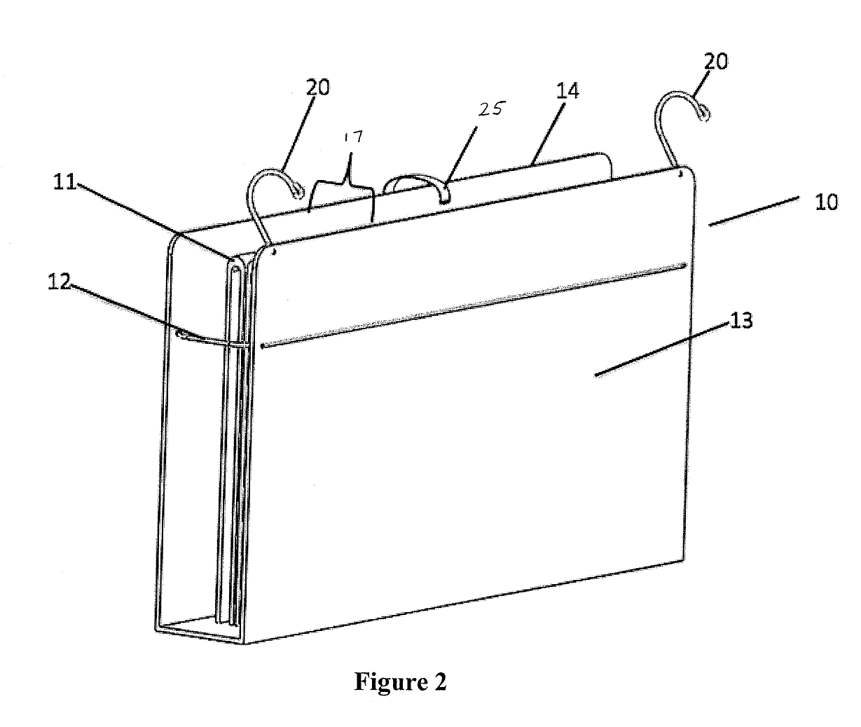

Further tensioning of the panels 13 and 14 as well as containment of the bags 11 could be accomplished with the inclusion of a closure strap 25 across the top opening 17 as illustrated in FIG. 2. For example the strap 25 could be made of either an elastic or fixed length material, and could include quick connect/disconnect means for attaching to the front panel 13 and/or back panel 14. The closure strap 25 can serve to further tension the panels 13 and 14 and retain bags 11. In one embodiment, the closure strap is permanently attached to back panel 14, for example by a rivet or stitching etc. The other end of the strap 25 could contain the quick connect/disconnect fasteners for attaching to the front panel 13. The quick connect/disconnect fasteners could, for example, be a snap, button, hook and loop, latch etc. It is desirable for such a tensioning and containment strap 25 to be very easy to secure and release, so as not to encumber the quick and easy loading/unloading of re-useable bags 11 through the top opening 17. Therefore, by permanently attaching the closure strap to one panel and then facilitating a quick connect/disconnect with another panel, an efficient closure mechanism may be accomplished.

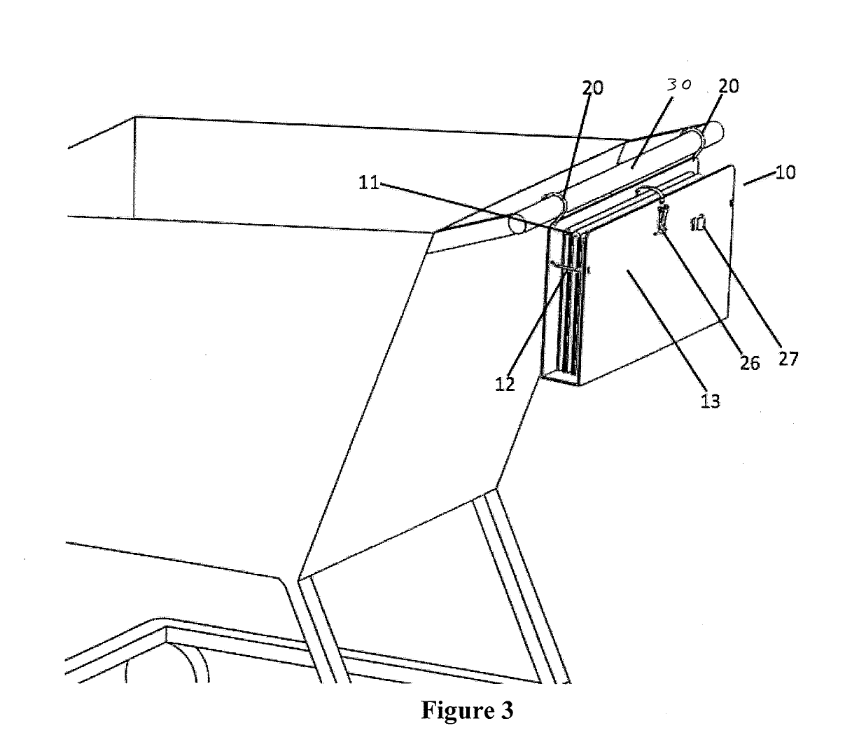

FIGS. 2 and 3 illustrate an embodiment in which container 10 includes two hook features 20. The hooks 20 allow the container to easily be attached to a shopping cart. For example, as illustrated in FIG. 3, the container could be attached to a handle 30 of a cart via hooks 20. Alternatively, the hook feature(s) could, for example, attach over any of the side rails of the cart. Single or multiple hook variants could be included on the container to facilitate various attachment locations and positions on the cart. The cart attachment location and resulting container orientation may enable the various shopping utensils included with the container 10 to be conveniently and readily accessible to the shopper during the course of shopping. Additionally, this may ensure the various shopping utensils do not occupy space in the cart intended for merchandise, and furthermore, ensure the shopping utensils do not get buried in the cart by merchandise.

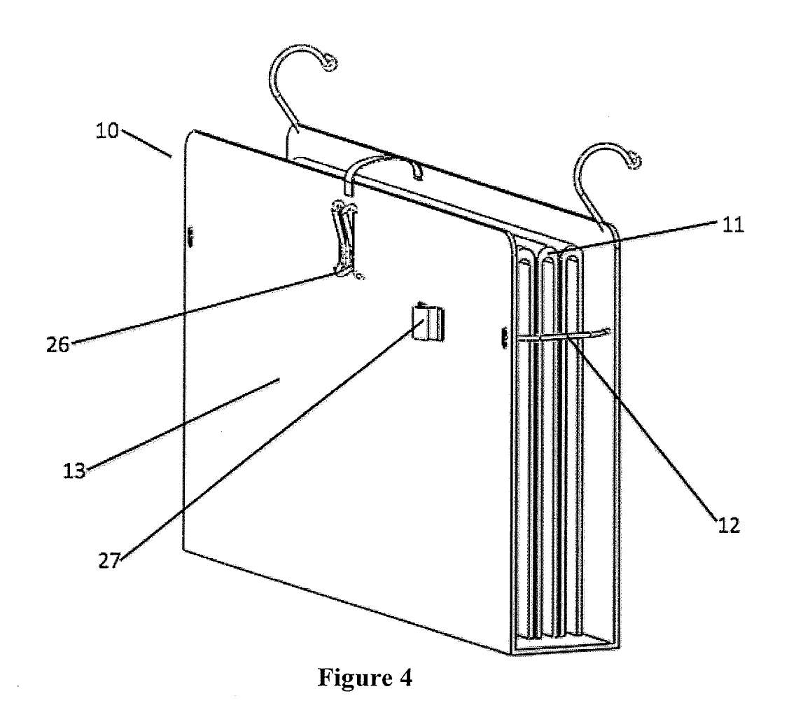

FIG. 4 illustrates a list holder 26 attached to front panel 13. The list holder 26 is designed to hold a single and/or multiple pieces of paper such as shopping lists/coupons/recipes/etc. The panel area beneath the various list(s) should contain a rigid or semi-rigid material that can act as a suitable writing surface. In this manner, a user can, for example, write on a shopping list while it is attached to the container 10. FIG. 4 also illustrates an embodiment of a pen holder 27 that is included as part of the container. Item 27 is referred to as a pen holder, but could be used to hold other writing utensils such as pencils, markers etc. The pen holder 27 could, for example, be constructed of a nylon strap attached to a container panel in such a manner to create a loop as shown in FIG. 4. A writing utensil such as a pen can be inserted into the loop strap or clipped to it via the pen clip. Many other embodiments of writing utensil holders that may be used with the pen holder 27 are contemplated. As previously stated, the container is preferably attached to the cart in a location and position that enables the various shopping utensils to be conveniently and readily accessible to the shopper during the course of shopping. Such position could be facilitated, for example, by placing the hook features 20 on the back panel 14, while the list holder 26 and pen holder 27 could reside on the front panel 13. In this manner, when container 10 is attached to the cart, the front panel 13 including list holder 26 and pen holder 27 could be readily accessible to the shopper. This configuration is illustrated in FIG. 3.

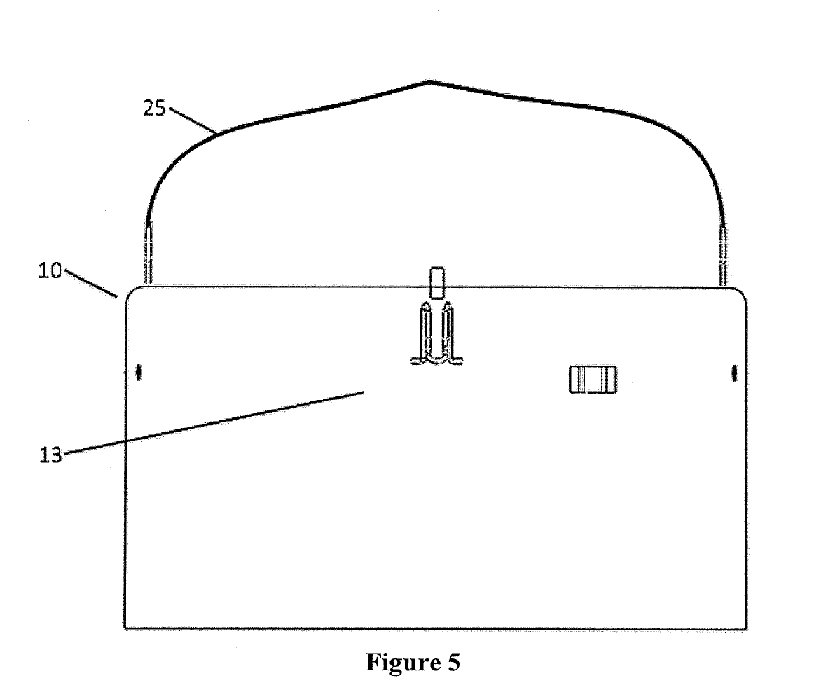

FIG. 5 illustrates a container 10 that includes a carrying strap 25. The strap allows the container 10 to be easily picked up and carried, for example from the car to the store. In one embodiment the container 10 could include a single strap 25 that anchors to the front panel 13 on one end and back panel at the other end. A single strap may be easier to grab and interact with. Other embodiments exist that contain multiple carrying straps 25 attached at various locations on the container 10.

For any of the embodiments of the present disclosure, corrugated polypropylene sheet, such as those commonly used as packaging material, signs, and point of purchase displays, is one example of a material that could be used to create the panel portion of the container. The corrugations improve the rigidity of the sheeting material. As previously discussed, a rigid panel may be desirable to help collapse the bags. Corrugated polypropylene sheets can be sourced, die cut, and formed very efficiently and cost effectively. The cost efficiency of this design intends to enable the overall container to be offered to consumers at very affordable prices in an attempt to encourage wide spread use and adoption. Additionally corrugated polypropylene sheets also presents efficient means for incorporating some of the other container features. For example, parallel grooves are contained within the sheet as a result of the corrugations. An opening in the panel surface could expose these grooves. Hook 20 and list holder 26 could be made from a wire form fabrication method. The wire form could be designed to partially engage with the corrugated grooves through an opening in the panel. In this manner a wire form version of hook 20 and list holder 26 could be attached to the panel with no additional fasteners required and minimal assembly labor. This construct further supports an affordable retail price. Additionally, corrugated plastic sheets can be made and sourced out of recycled plastic materials. Constructing a substantial portion of the container from recycled materials would be intriguing to many consumers who would consider buying such a container.

A corrugated polypropylene sheet can also act as a writing surface. The benefit of a writing surface beneath the list holder was previously described. Using the actual panel to provide this writing surface simplifies the design and overall cost by avoiding the need to incorporate another component to act as a writing surface.

In summary, the container of the present disclosure can provide convenient means for storing, transporting, and carrying shopping utensils. The container can provide means to help collapse and retain re-useable shopping bags. The container can allow the top opening to enlarge for quick and easy loading/unloading of re-useable bags. The container can include feature(s) that allow the container to be attached to shopping carts. The attachment position can enable the various shopping utensils included with the container to be conveniently and readily accessible to the shopper throughout the course of shopping. The container can include feature(s) that allow lists, coupons, recipes and the like to be quickly attached and detached from the container. The container can include provisions for holding a writing utensil. The container can also include a writing surface.

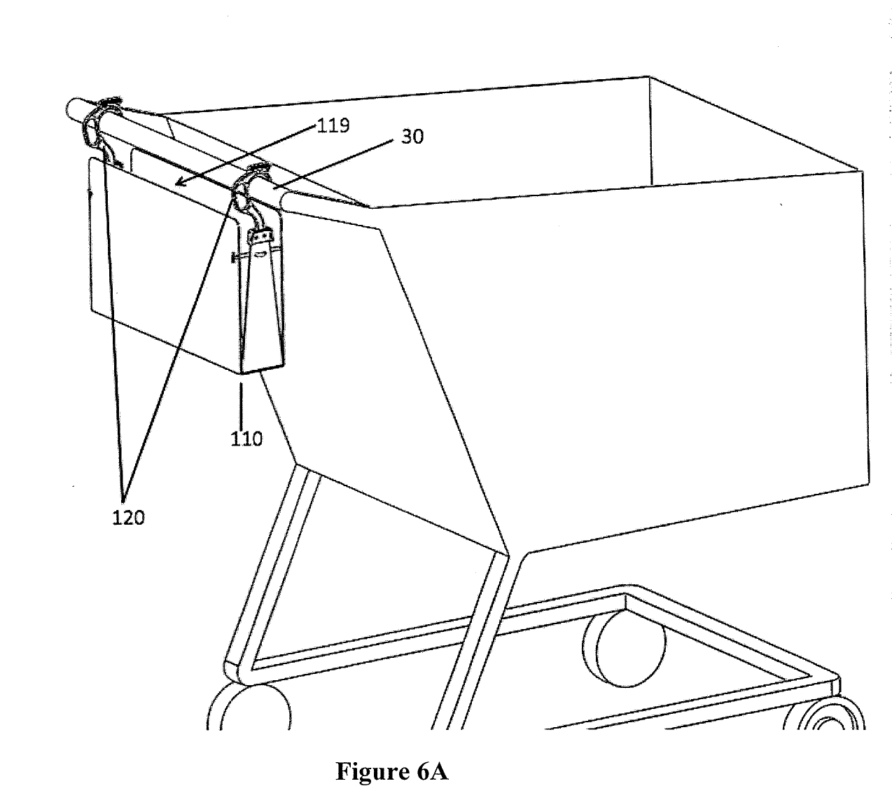

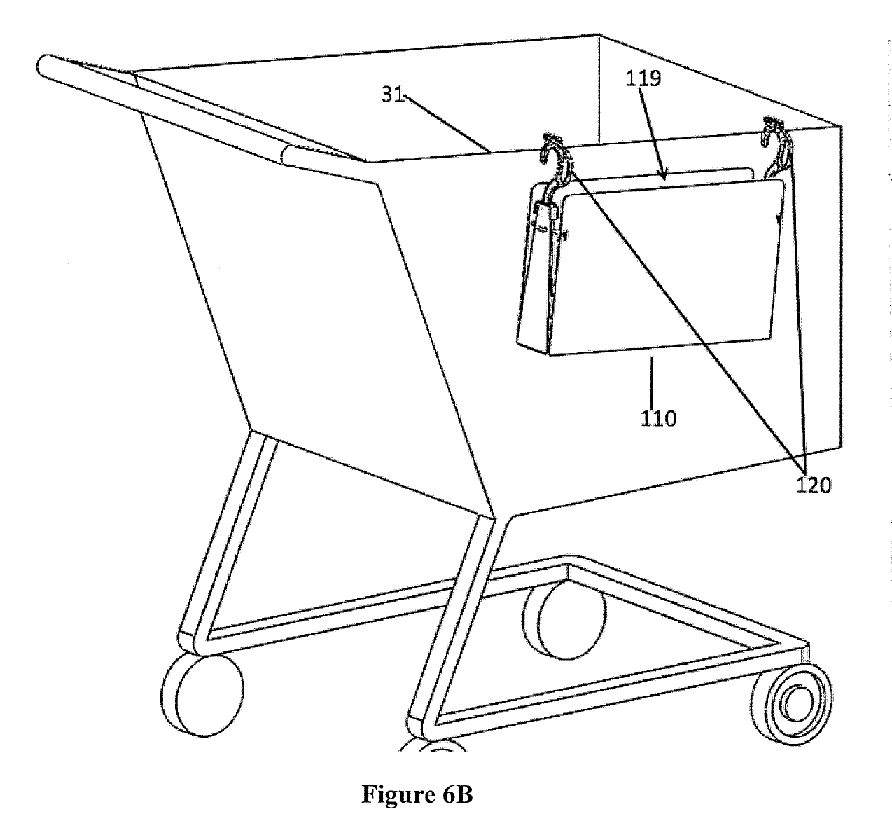

Various embodiments of another container 110 for shopping utensils are illustrated in FIGS. 6-10. In this context, shopping utensils includes re-useable shopping bags, shopping lists, coupons, recipes, writing utensils, pocket items such as wallet and keys, and the like.

FIGS. 6A and 6B illustrate an embodiment of a container 110 including a cavity 119 and two hooks 120. The hooks 120 are configured to enable the container 110 to be operably rapidly detachably engaged to a shopping cart. For example, as illustrated in FIG. 6A, the container could be attached to a cart handle 30 via hooks 120. Alternatively, the hooks 120 could also attach to the cart sidewalls by engaging the hooks 120 over the upper cart frame 31. The cart attachment positions identified in FIGS. 6A and 6B in conjunction with the container's 110 design arrangement, which will be further specified in the following paragraphs, enables the shopping utensils contained therein to be conveniently accessible during the course of shopping.

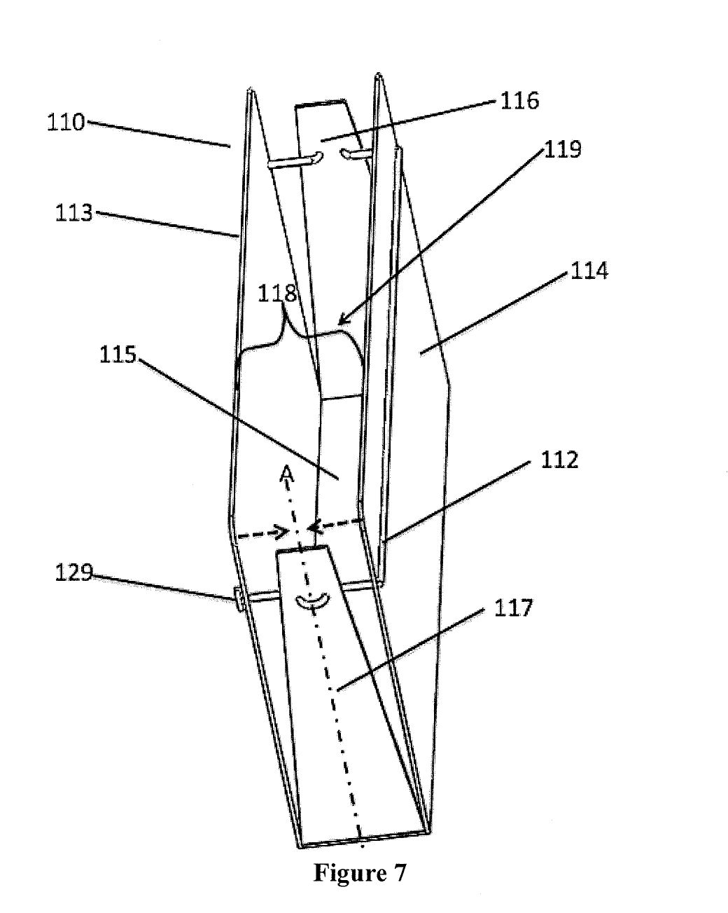

FIG. 7 illustrates a container 110 constructed with a front panel 113, back panel 114, bottom panel 115, left side panel 116, and right side panel 117. This panel design arrangement creates a container cavity 119, which includes a cavity opening 118, configured for receiving and storing re-useable shopping bags. As illustrated, this embodiment may be configured without a top panel; this may facilitate quick, easy loading and unloading of shopping bags through the cavity opening 118.

The container embodiment illustrated in FIG. 7 includes a cord 112, which is cooperatively engaged with front panel 113, back panel 114, left side panel 116, and right side panel 117. The cooperative engagement between the cord and panels helps support the container structure, thereby facilitating the form of container cavity 119. The front panel 113 and back panel 114 are constructed from a rigid or semi-rigid material. In a preferred embodiment cord 112 is an elastic cord cooperatively engaged with front panel 113 and back panel 114 to tension said panels toward axis A as indicated by the arrows in FIG. 7. The rigid panel construction of front panel 113 and back panel 114 cooperatively works with the tensioning force from elastic cord 112 to collapse the cavity 119 thereby promoting compact storage of shopping bags. The elastic cord 112 for example, could be a single cord fixated to the front panel by cord anchors 129. As illustrated in FIG. 7, the cord 112 routes through clearance holes in the side panels, and traverses across the outer surface of the back panel 114. In this manner, elastic cord 112 can provide structural support to the container 110 as well as promote collapsing force on items in the cavity such as shopping bags. Alternatively, many other elastic material configurations could be configured to help support and collapse the panels. Some alternatives, for example, could include multiples elastic cords, elastic bands wrapped fully around the perimeter of the container, elastic cord(s) woven in various patterns back and forth between front panel 113 and back panel 114, a closing strap or panel that traverses across cavity opening 118 to tension front panel 113 and back panel 114 towards each other.

In addition to assisting with collapse and containment of shopping bags, elastic cord 112 also serves as an easy open/close mechanism. For example, to load or remove a shopping bag from the cavity 119 thru cavity opening 118, the user simply has to move front panel 113 and/or back panel 114 away from axis A. While separating the front panel 113 and back panel 114, the elastic cord(s) can easily stretch allowing the cavity opening 118 to enlarge for quick and easy loading/unloading of shopping bags. In this manner, no user interactions may be required with the elastic cord(s) 112. The user can simply open the panels to gain access to the bags, and then subsequently release the panels to allow them to collapse back down.

Other methods for tensioning panels 113 and 114 could be accomplished via tie strings, latches, buckles, tensioning straps and the like. In addition to the easy open/close mechanism accomplished with the design arrangement illustrated in FIG. 7, the elastic cord 112 can also provide a limit on how far the cavity opening 118 can open. In this manner, the cavity opening 118 can be enlarged far enough to facilitate easy loading/unloading of shopping bags, but not so far that bags could unintentionally fall out of the container. In contrast, an alternative embodiment previously described could use tie strings to tensions the panels 113 and 114.

The front panel 113, back panel 114, bottom panel 115, left side panel 116, and right side panel 117 could be separate panels engaged together to create cavity 119, or alternatively could be fabricated from a single sheet cut and then formed into the container shape. In other embodiments as discussed previously, the container may be constructed without left and right side panels, which further allows front panel 113 and back panel 114 to fold inward towards axis A. Please refer to FIG. 1 for a similar construction. As the panels fold inward, the re-useable bags 11 will be collapsed and retained. In the example depicted in FIG. 1, three re-useable shopping bags 11 are contained within the cavity, with the bags illustrated folded approximately in half. Collapsible side panels could alternatively be incorporated to further conceal and retain the bags without disrupting the ability of the rigid panels to collapse inward on the bags. A collapsible side panel could, for example, be constructed of any number of pliable materials, such as fabric, mesh, folded sheeting and the like. FIG. 7 illustrates tapered side walls 116 and 117 whereby front panel 113 and back panel 114 are allowed to move closer to axis A near the cavity opening 118 (the side panels taper smaller in this vicinity), however front panel 113 and back panel 114 can not move as close to axis A in the areas nearer to the bottom panel 115.

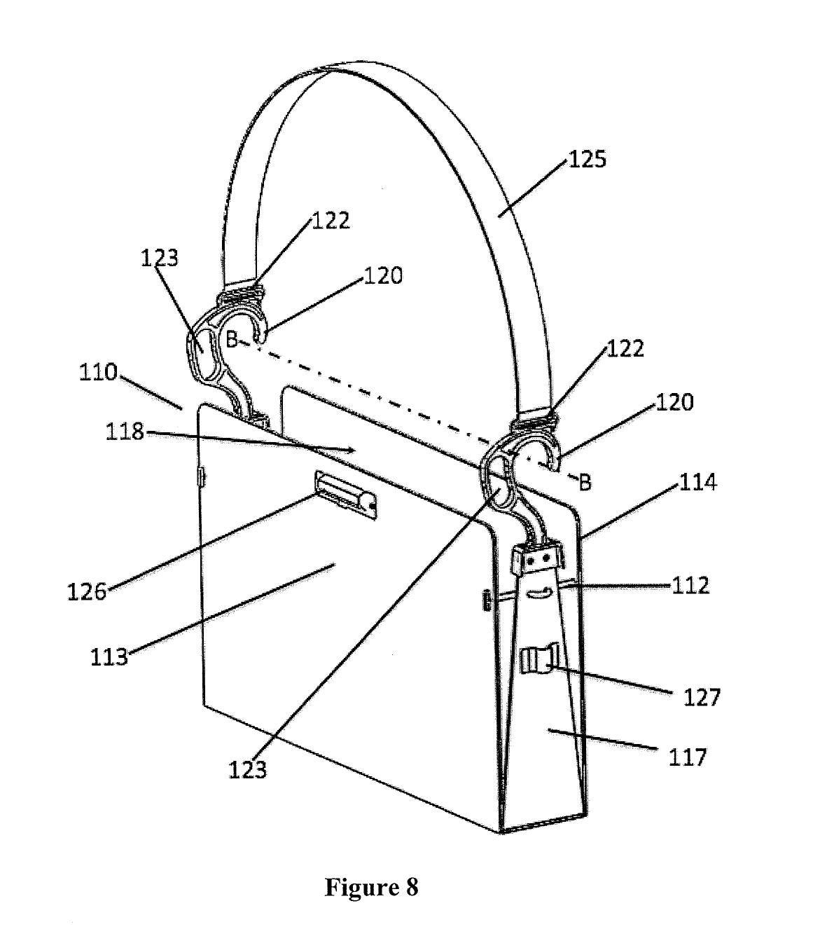

In the version of the container 110 illustrated in FIG. 8, a list holder 126 is attached to front panel 113. The list holder 126 is designed to hold a single and/or multiple pieces of paper such as shopping lists, coupons, recipes and the like. The panel area surrounding list holder 126 can utilize a rigid or semi-rigid construction that can act as a suitable writing surface. In this manner a user can write for example on a shopping list while said list is attached to the container 110. FIG. 8 also illustrates an embodiment of a pen holder 127 positioned on an outside surface of the container which facilitates easy access while shopping. Item 127 is referred to as a pen holder, but could be used to hold other writing utensils such as pencils, markers and the like.

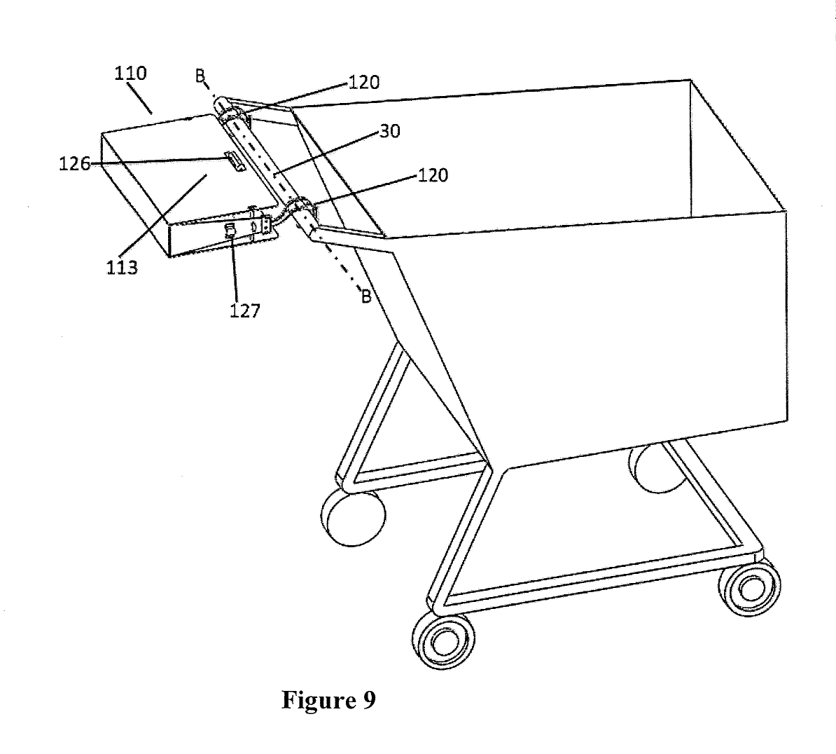

To further facilitate viewing and interacting with items (such as shopping lists) attached to the container by list holder 126, the hooks 120 are arranged and configured to enable the container 110 to be pivotably rotated about a hook axis B illustrated in FIGS. 8 and 9. For example, as illustrated in FIG. 6A, the container 110 is attached to the handle of a cart 30 such that, in a resting position, the writing surface of front panel 113 is oriented in a substantially vertical orientation. The user can optionally pivot the container about hook axis B (and cart handle 30) to various alternative positions such as that shown in FIG. 9, in which the writing surface of front panel 113 is oriented substantially horizontal. In this manner the container 110 can be pivoted into positions that facilitate easy viewing of items attached to the container via list holder 126, while said pivotable positions additionally facilitate use of the writing surface.

The container 110 embodiments shown in FIGS. 6A, 6B, 8, 9, and 10 include two hooks 120. The hook embodiments 120 facilitate multiple functions. As previously noted in FIGS. 6A and 6B, hooks 120 are arranged for a preferred mounting location to the cart handle 30 or alternatively attached to the cart sidewalls by engaging the hooks 120 over the upper cart frame 31. Also previously noted, the design arrangement facilitates pivoting about a hooks axis B while attached to the cart.

Additionally, as shown in FIG. 8, hooks 120 may include carrying strap attachment features 122. Attachment of a carrying strap 125 allows the container 110 to be easily picked up and carried, for example from the car to the store. As illustrated, the location of carrying strap attachment feature 122 is positioned atop the hook so as to minimize the ability for the carrying strap 125 to interfere with engagement between hooks 120 and a cart. Additionally, the carrying strap attachment feature 122 further positionally enables operative control to engage and disengage the container to and from a cart, via hooks 120, as being hand carried and controlled through the carrying strap 125. For example, the design arrangement including the carrying strap 125 attached to the hooks 120 enables a user to easily steer said hooks into engagement with a cart.

Additionally as illustrated, the hooks may include finger loops 123. This feature creates an alternative user interface that can be operatively engaged by a user to attach/remove the container 110 to and from a cart via hooks 120. As illustrated in FIGS. 6A, 6B, 8, 9, and 10, the hooks 120 are attached to left side panel 116 and right side panel 117. This design arrangement isolates the hooks from movement while a user opens the cavity opening 118. For example as front panel 113 and/or back panel 114 move toward or away from each other, as would occur during the action of opening or closing the cavity opening 118 to access bags, side panels 116 and 117 and hooks 120 remain detached from the opening and closing movement of the container. Additionally hooks 120 could be fabricated to include a gripping surface, for example an elastomer overmold, that helps prevent sliding motion for example between hooks 120 and cart handle 30. Such gripping provisions would be beneficial as container 110 is for example attached to a cart and moving or turning in conjunction with said cart.

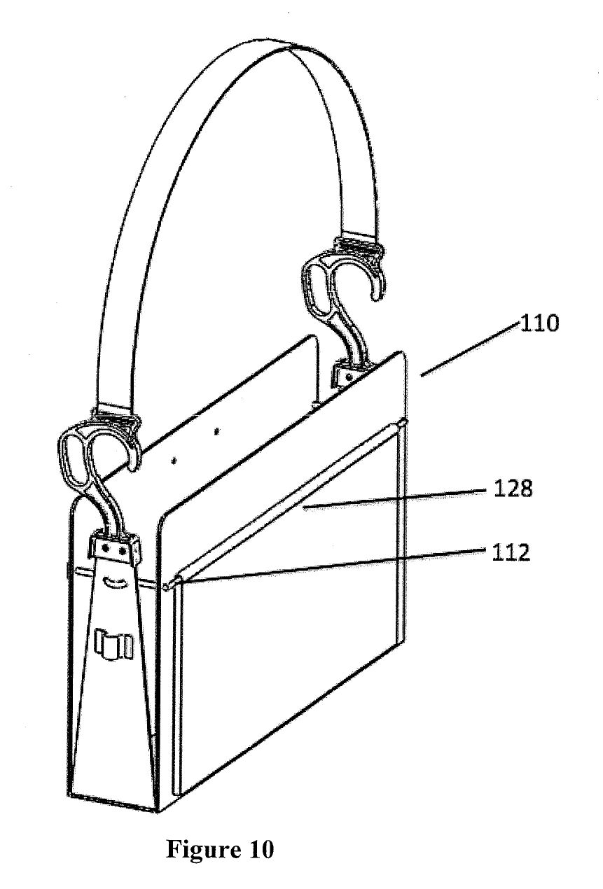

FIG. 10 illustrates a version of the container 110 that includes a pocket 128. The pocket is sized, arranged, and configured to receive personal shopping items, for example: shopping lists, coupons, recipes, writing utensils, pocket items such as wallet, keys, phone and the like. The embodiment illustrated in FIG. 10 presents elastic cord 112 as being cooperatively engaged with pocket 128 to help facilitate closing the pocket and retaining its contents.

Although in the foregoing description, terms such as “top”, “bottom”, “front”, “back”, “right”, “left”, “upper”, and “lower” may have been used for ease of description and illustration, no restriction is intended by such use of the terms. The containers described herein can be used in different orientations, depending upon the desired application.

Having described the preferred aspects and embodiments of the present disclosure, modifications and equivalents of the disclosed concepts may readily occur to one skilled in the art. However, it is intended that such modifications and equivalents be included within the scope of the claims which are appended hereto.

1. A container for shopping utensils, comprising:
(a) a storage cavity arranged and configured to receive shopping bags, said storage cavity defined by:
(i) rigid front and back panels, said front and back panels positioned substantially opposing each other and arranged and configured for operable movement towards and away from each other;
(ii) a bottom panel connecting said front and back panels, said bottom panel configured to define a bottom end of said storage cavity; and
(iii) a cavity opening, said cavity opening arranged and configured for receiving the shopping bags therethrough, said cavity opening configured to change in size as said front and back panels operably move in an opposing direction away from each other and also as said front and back panels operably move toward each other;
(b) a tensioning band, said tensioning band cooperatively engaged with said front and back panels and configured to limit the operable movement of the front and back panels in the opposing direction away from each other; and
(c) a cart attachment structure, said cart attachment structured configured to enable the container to be rapidly detachably engaged with a shopping cart.

2. A container according to claim 1, further comprising two side panels positioned substantially opposing each other, said side panels arranged and configured to engage with said bottom panel of the container to further define the storage cavity.

3. A container according to claim 2, wherein said tensioning band is cooperatively engaged with said front and back panels and also with said side panels.

4. A container according to claim 1, wherein said tensioning band is configured to apply a continuous tensioning force to urge said front and back panels toward each other when the cavity opening is larger than a predetermined size.

5. A container according to claim 1, wherein said tensioning band is constructed of elastic materials.

6. A container according to clam 5, wherein the tensioning band is configured to elastically stretch as said front and back panels operably move in the opposing direction away from each other a predetermined distance, wherein said tensioning band, when in the elastically stretched condition, applies a force that urges said front and back panel back towards each other.

7. A container according to claim 1, further comprising a list holder arranged at an exterior surface of said container.

8. A container according to claim 1, further comprising a hard writing surface defined on an exterior surface of said container.

9. A container according to claim 1, further comprising a pen holder arranged on an exterior surface of said container.

10. A container according to claim 1, wherein the cart attachment structure is defined by a pair of hooks.

11. A container according to claim 10, wherein said hooks are arranged and configured for rapid detachable engagement with a tubular handle of a cart.

12. A container according to claim 10, wherein said hooks further include finger loops that enable a user to operably attach said container to or remove said container from the cart.

13. A container according to claim 10, wherein said hooks define a gripping surface, said gripping surface arranged and configured to prevent lateral sliding of the container while the container is attached to a cart via said hooks.

14. A container according to claim 1, wherein the cart attachment structure enables the container to be pivoted while attached to the shopping cart.

15. A container according to claim 7, wherein the cart attachment structure enables the container to be pivoted while attached to the shopping cart from a generally vertical position to a generally horizontal position, enabling an item attached to the list holder to be able to be optimally viewed.

16. A container according to claim 8, wherein the cart attachment structure enables the container to be pivoted while attached to the shopping cart from a generally vertical position to a generally horizontal position, enabling the hard writing surface to be able to be operably used.

17. A container according to claim 1, further comprising a carrying strap, wherein said carrying strap is engaged with said cart attachment structure.

18. A container according to claim 2, wherein said cart attachment structure is attached to said container at said side panels.

19. A container according to claim 18, wherein the front and back panels are configured and arranged to be operably moved in the opposing direction away from each other against the bias of the tensioning band without interfering with the attachment of the container to the shopping cart via the cart attachment structure.
